(19) United States
(12) Patent Application Publication
(10) Pub. No.: US 2012/0130909 A1
(43) Pub. Date: May 24, 2012

(54) Product Tracking and Alert System

(75) Inventor: Jonathan Charles CORN, Del Mar, CA (US)

(73) Assignee: RV-ID, INC., Solana Beach, CA (US)

(21) Appl. No.: 13/300,432

(22) Filed: Nov. 18, 2011

Related U.S. Application Data
(62) Division of application No. 11/890,203, filed on Aug. 3, 2007.
(60) Provisional application No. 60/837,275, filed on Aug. 10, 2006.

(51) Int. Cl. G06Q 10/00

(52) U.S. Cl. 705/303

(57) ABSTRACT

Radio transponder encoded with serial number linked to a vehicle's VIN is installed in a vehicle prior to retail sale. When vehicle is brought in for service, the presence of vehicle at the service facility is detected, and checked against a database of recalls, recall repairs completed, state consumer protection Lemon Laws, and service history. This information is stored within a database that can be viewed via the Internet. Electronic alerts can be automatically generated indicating when vehicle is in service and which recall repairs are to be performed, and if Lemon Law limits being approached or exceeded. The system helps ensure that recall repairs are completed and the manufacturer can get involved before consumer remedies are triggered. The system allows lenders to conduct collateral floorchecks remotely and detect irregular business practices, and allows dealers to locate and manage inventory, conduct warranty repairs, and seek warranty reimbursements.

### CROSS-REFERENCE TO RELATED APPLICATIONS

This application claims priority from U.S. Provisional Patent Application No. 60/837,275 filed Aug. 10, 2006.

### BACKGROUND OF THE INVENTION

1. Field of the Invention

This invention relates to the field of vehicle, trailer, equipment and boat tracking. More particularly, this invention relates to the field of an automated system for tracking vehicles, trailers, and boats, and for providing certain information about those products to their manufacturers, dealers, lenders and users.

2. Description of Related Art

Radio frequency identification (RFID) technology is a well-known technology that utilizes a small radio frequency receiver/transmitter (transponder) to respond to a corresponding interrogator (reader) unit, and send back a signal that uniquely identifies the object to which the RFID device is attached. In this way an object can be automatically and uniquely identified at a distance using only radio frequency interrogation. RFID devices include both active and passive devices, and read-only and read/write devices.

Various systems have been proposed in the past for using RFID or other identification technology to facilitate vehicle diagnostics and repairs. U.S. Patent Publication No. 2005/0086070 proposes a system in which a user uses a handheld wireless device to read a vehicle identification number (VIN) using a scanner such as a barcode scanner, or manually enters the VIN, and uses the wireless device to retrieve information about the vehicle including information from Carfax.

U.S. Patent Publication No. 2004/0095244 purports to disclose a tire identification label that can have an integral RFID tag. The RFID tag is placed on a tire and used to match the tire with a VIN, so that user can know what vehicles have what tires for recall purposes.

U.S. Pat. No. 5,072,380 issued to Randelman et al. describes using electronic equipment to identify vehicles within a service area and for invoicing the vehicle owner. The system may be used for vehicle maintenance alerts, recalls, and specification attainment.

U.S. Pat. No. 5,058,044 issued to Stewart et al. discloses a system for automatically identifying vehicles and assimilating data from an identified vehicle. The system provides a service record of the vehicle for providing a statement of account indicative of a transaction involving the vehicle.

U.S. Pat. No. 5,442,553 issued to Parrillo discloses a system in which vehicles send their on-board diagnostic information via radio frequency. The manufacturer uses the information to help formulate recall and maintenance procedures.

U.S. Pat. No. 5,459,304 discloses using “smart cards” for use in identifying parking garage entries and exits, and toll road usage.

U.S. Pat. No. 5,995,898 issued to Tuttle discloses an RFID system in communication with a vehicle on-board computer. The system purports to automatically track vehicles entering and leaving lots, and facilitates the automation of vehicle service monitoring and billing.

U.S. Pat. No. 6,170,742 issued to Yacoob discloses a computerized “smart card” associated with a vehicle that is used to track the life history of the vehicle including maintenance and service.

U.S. Pat. No. 6,822,582 issued to Voeller et al. discloses an RFID device associated with a vehicle that is configured to store data associated with a vehicle service procedure in the RFID device.

### SUMMARY OF THE INVENTION

Vehicle manufacturers have another serious challenge to their business bottom lines in the form of breach of warranty laws, including so-called “Lemon Laws.” Such provisions are consumer protection laws whose goal is to help ensure that manufacturers that provide warranties with their products, provide successful warranty repairs within a reasonable amount of time and within a reasonable number of repair attempts. If the manufacturer/warrantor fails to satisfy such conditions, it can be required to either replace or repurchase the product, which can be a very expensive proposition. This is especially true when the vehicle is a motor home. It would therefore be highly desirable for a manufacturer to be able to track time of sale (i.e., warranty start date), vehicle location, and accumulation of repair time and/or repair attempts, and for automatic alerts to be issued to the manufacturer and/or to the repair shop, or to track other parameters (e.g. recall requirements) which can trigger legal remedies under such consumer protection laws to alert the manufacture and/or the repair facility and/or the manufacturer that repair limits are being approached or have already been exceeded. The present invention provides that capability.

In some states, retail sellers (e.g., dealers) can also be subject to such or similar consumer protection laws. Therefore, the capabilities of the present invention would be helpful to them as well. Dealers would also receive other benefits from the present invention including, but not limited to: (i) automated population of some warranty claim form fields; (ii) inventory location information (which would be particularly useful for large dealerships); (iii) instant information on customers as they enter the dealer's facility for service; and (iv) instant information on customer's products as they enter the dealer's facility for service.

Equipped with a radio frequency identification (RFID) transponder, or other position identifying technology such as global positioning system (GPS) tracking or a radio frequency transponder, a vehicle or other product can be monitored within a certain geographical boundary. In this case, the geographical boundary is the area that circumscribes the dealer's product display areas and the invention would allow users to remotely detect (i) whether a product is on the dealer's lot; (ii) the location within the dealer's lot; (iii) the date and time of any movement within the lot; and, (iv) the date and time of entry or exit from the lot. This information is then transmitted, such as via the Internet, to a computer program and database. The program then checks its database to see the vehicle's maintenance history and to see if the vehicle is subject to any safety recall or warranty bulletin repairs. It times the length of the repair visit and calculates the cumulative number of days that the vehicle has spent in the shop for warranty repairs. The system can keep track of the time spent in the shop on a total cumulative basis for all repairs, on a cumulative basis for any one particular type of consumer complaint or symptom, on a cumulative basis for any particular visit or during any particular repair, or based on other parameters that might be relevant for purposes of avoiding repurchase or replacement requirements, or other penalties imposed under various state or federal consumer protection statutes, or other statutes, rules, or regulations. All of the information may be presented on a secure website for credentialed subscribers. Subscribers can also choose to receive information via an automatically generated email or other communication. The invention allows the manufacturer, for example, to get involved early to ensure that Lemon Law limits are not exceeded and thus to ensure that an expensive buy-back requirement under the law is not triggered.

Additionally, the present invention helps the manufacturer ensure that all recall repairs including critical safety recall repairs are performed, by alerting the manufacturer and the repair facility when a unit enters a repair facility for which those repairs have not yet been performed.

The unit's repair history can also be written into the transponder's memory, much like a patient's hospital chart, so that technicians can benefit from the efforts of prior repair attempts, including not trying the same repair that failed to fix the problem the last time.

Additionally, the system may be used to automate requests for warranty repair reimbursement from the dealer to the manufacturer, and the reimbursement payments to the dealer.

Additionally, the system may be used to identify features and options, time at the sales dealership, number of test drives, and vehicle placement (i.e., shelf space) on a dealership lot in order to better analyze sales data.

In one aspect therefore, the present invention is of a method, and a system for implementing the method, the method including the steps of automatically detecting the presence of a vehicle such as by radio frequency identification or other detection technology at a repair facility such as a factory authorized repair facility or dealership, calculating at least a first parameter in accordance with a cumulative time spent by the vehicle at least one repair facility, comparing the first parameter to a stored value, and if the first parameter exceeds the stored value, automatically generating an alert message indicating at least one of the cumulative time, that the cumulative time is approaching or has exceeded a predetermined value, and a difference between the cumulative time and a predetermined value, and sending the message to the repair facility and/or the manufacturer of the vehicle. The maximum allowable cumulative time spent in the shop or the maximum number of repair attempts are determined by state Lemon Law statutes or other consumer protection laws applicable to the state whose laws will control the consumer's remedies, and the thresholds for triggering alert messages may be set at various levels depending on how much advance alert notice the manufacturer and/or the repair facility wishes to receive. The cumulative time can be measured in either calendar days or business days depending on the particular state's laws. Additionally, the alerts can be generated based on the number and type of repair attempts, indicating that the maximum allowable number of repairs is being approached for that particular type of repair, in accordance with the controlling law and the desire for advance notice. Additionally, alerts can be generated to help the manufacturer analyze real time sales data through vehicle location and time of sale tracking. The message may be an electronic alert that a repair attempt will be the last attempt permissible before legal remedies are triggered. For example, the message may state that the vehicle may experience only five more days in the repair shop, or only one more attempted repair on the vehicle's braking system, before the consumer will be legally entitled to a replacement of the vehicle or a buy-back from the manufacturer. An alert may also be sent from the manufacturer to the repair facility indicating that the owner of the vehicle should be accorded special handling. After the repair is completed, the vehicle is automatically detected as leaving or as having left the repair facility. The information regarding vehicles and their repair histories may be kept within a database maintained by the manufacturer. The database is updated with the type of repair made, and the time spent in the shop for that visit, and the cumulative time spent in the shop for repairs is updated accordingly.

In another aspect, the present invention is of a method, and a system for implementing the method, the method including automatically detecting a presence of a vehicle at a repair facility and automatically reading the VIN such as from an RFID unit or transponder on the vehicle, reading a first memory such as a database maintained by the vehicle manufacturer regarding any safety recalls that have been issued and for what VINs those safety recalls have been issued, and reading either a second memory such as the database or a memory contained on the vehicle's RFID unit or transponder to determine whether the particular repair associated with the safety recall has been performed, and if not, then sending an electronic alert to the repair facility and/or to the manufacturer indicating that a vehicle has just entered the repair shop for which a safety recall repair needs to be performed.

In another aspect, the present invention is of a method, and a system for implementing the method, the method including using an automated identification system to remotely sense a presence of a vehicle and read its VIN, receiving an input regarding a repair made to the vehicle, and generating and sending an electronic reimbursement request from the repair facility to the vehicle manufacturer requesting reimbursement for warranty repair work performed by the repair facility.

Another aspect of the invention relates to automating the lender audit process, which currently requires considerable labor and expense. Many, if not all, retail sellers of vehicles, trailers, boats and equipment finance their inventories with funds provided by wholesale lenders. These lenders have a security interest in the merchandise and the retailer is legally obligated to (i) keep the collateral on its premises and (ii) pay off the loan immediately upon sale of the secured chattel. To protect and monitor their loan collateral, lenders regularly send auditors to the borrowers' facilities to inspect inventory. This is a cumbersome and expensive process that is difficult for both the lender and the borrower. Moreover, the accuracy of hand counting inventory is often confounded and complicated by various factors outside the lender's control. Therefore, it would be highly desirable to automate the audit process using electronic means. Such electronic means would be more accurate and efficient than the current manual process and it could be far less expensive. The present invention would provide this capability as it could monitor the position of products in dealer inventory, electronically notify lenders as products leave the inventory premises, and allow for Internet interactivity. The present invention provides that capability.

Many manufacturers vehicles, trailers, boats and equipment distribute their products through independent retailers that purchase products from manufacturers at a wholesale price and sell them to consumers at higher retail prices. Since these retailers often sell multiple and competing brands, manufacturers vie for favorable “shelf space” location within the retailer's display inventory. Often manufacturers will negotiate terms favorable to the retailer in exchange for the retailer's promise that its products will be displayed in premium locations on the retailer's premises. Since shelf space location is critically important to overall sales, such promises are integral to the manufacturers' overall sales strategy. However, large geographical distances can, and often do, separate manufacturers and retailers, and it is often difficult for manufacturers to enforce such shelf space promises. Therefore, it would be highly desirable for manufacturers to be able to monitor shelf space location within the dealer's display inventory electronically. The present invention provides this capability.

Exemplary embodiments of the invention will be further described below with reference to the drawings, in which like numbers refer to like parts.

### BRIEF DESCRIPTION OF THE DRAWINGS

FIG. 1 is a simplified system diagram of the present invention.

FIG. 2 is a simplified flow diagram of the present invention.

### DETAILED DESCRIPTION OF THE PREFERRED EMBODIMENTS

I. Monitoring Repair Time, Attempts, and Other Relevant Repair Parameters

Consumer protection laws, including state Lemon Laws, vary from state to state. Depending on the state, the laws may cover only consumer vehicles rather than vehicles used purely for commercial purposes, and may cover automobiles, passenger trucks, recreational vehicles, motorcycles, and/or other types of vehicle's. The triggering condition may be that a vehicle has experienced a certain number of business or calendar days at manufacturer's authorized repair facility such as an automobile dealership, or has experienced more than a specified number of warranty repairs, or has experienced at least a specified number of repair attempts to fix a serious safety hazard, or some combination of the above. Generally, at least some portion of the repair attempts must have occurred during the manufacturer's warranty period.

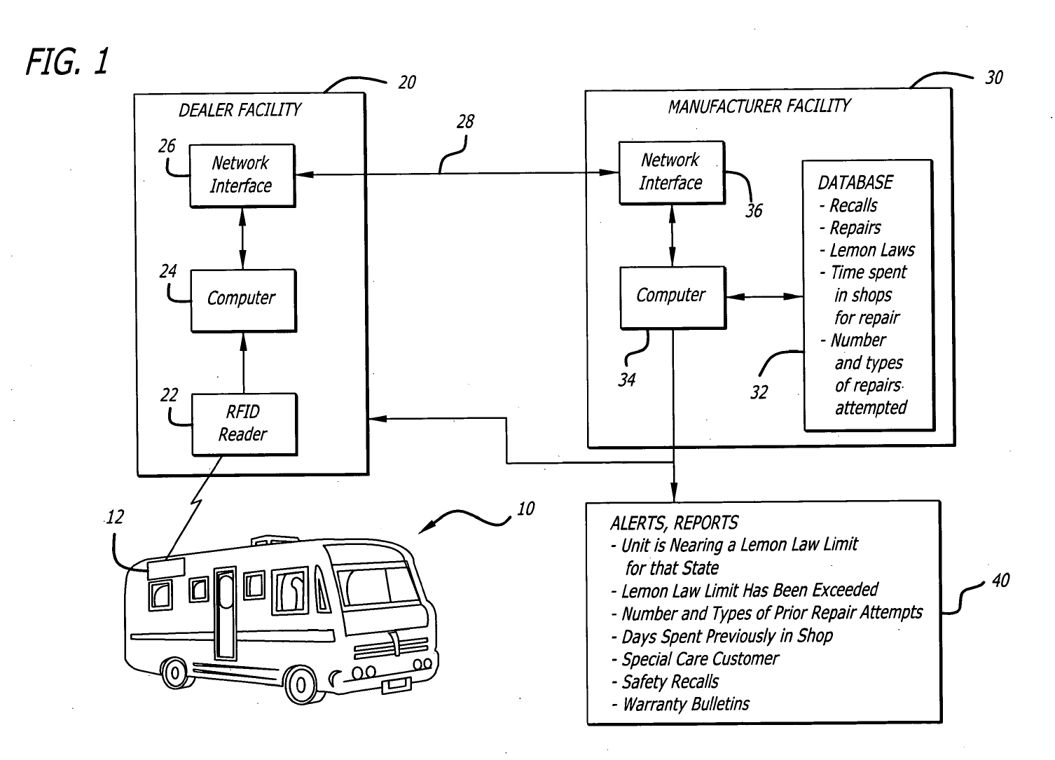

FIG. 1 is a simplified system diagram showing an illustrative embodiment of the system. Vehicle 10 has associated with it an identification device 12, which in the illustrative embodiment is a passive RFID transponder having read/write capabilities. It will be understood, however, that any identification device could be used, preferably one that allows a unique identification code such as a VIN or serial number to be automatically read at a distance whenever the vehicle enters or exits a defined area. For discussion purposes, identification device 12 will be simply referred to as an RFID transponder or RFID unit. Preferably the RFID unit is installed on the vehicle, and the VIN and any other pertinent information is written into the unit at the time of manufacture. When the unit is sold at retail, the system will detect the a change in the dealer's inventory level and record a sale. Alternatively, the dealer writes the sale date and mileage into the RFID unit or directly into the database.

When vehicle 10 enters a defined area 20 such as an authorized vehicle repair facility such as a dealer's yard when the vehicle is tendered for warranty repairs or is otherwise brought in by a customer for service, RFID reader 22 reads the VIN or other unique identifier from transponder 12, and reports the identifier and the date to dealer's computer 24. Dealer's computer 24 then transmits the VIN to the master database 34 at third party location 30, across a communication link 28 via network interfaces 26 and 36 at the dealer's side and master database's side, respectively. It will be understood that the master database 30 need not be physically located at an office or other facility of the manufacturer. For example, master database 30 could refer to any computer system maintained by or on behalf of the manufacturer. Communication link 28 is preferably the Internet, but may be any other communication link such as, for example, a Wide Area Network (WAN), the cellular telephone network, or the public switched telephone network, and may include any combination of wired wireless links within the communication chain. master database 34 is preferably a webserver. A message is sent to the master database whenever vehicle 10 is detected entering or leaving dealer facility 20. Preferably the reading distance is far enough that the vehicle will be detected upon entering the dealer's lot regardless of when the vehicle is finally brought into a repair bay to begin actual repair work. Dealer facility 20 may be a dealer repair shop or any other repair facility authorized by the vehicle manufacturer to perform service work on vehicle 10. Spurious vehicle detection, such as when a vehicle having an RFID unit merely drives past the facility on a nearby street and therefore the vehicle is detected as being present for only a short time, are not counted as vehicle entrances. This will be accomplished through parameter's established by the user using the system's Rules Engine. For example, the detection of a vehicle that shows an arrival and a departure within a short time frame (e.g., 5 minutes) could be automatically deleted from the database as an incidental contact. Additionally, confirmation by the repair facility that a particular vehicle has indeed been left for repairs may be required. Typically when a vehicle is brought in for repairs, a customer service representative meets with the customer and determines the symptoms being complained about and hence the type of repair needed. The customer service representative can then enter in the symptom information into the system, thus correlating the visit with a particular type of repair including whether the repair is of a type that is covered by the applicable state's Lemon Law.

Manufacturer's computer 34 is in communication with database 32. Database 32 is preferably a national database maintained by the manufacturer and may be located at the manufacturer's facility or some other facility. Local copies of database 32 may be maintained at the dealer's facility and queried. Database 32 includes data that is applicable generally, as well as specific history information for specific vehicles. The general information contained in database 32 includes: vehicle tracking data collected by electronic devices; recalls issued, the vehicle models and VINs to which those recalls apply; the specifics of state Lemon Laws; repair procedures, illustrations, parts lists, and related applicable information for use by mechanics in conducting safety recall repairs; dealer lot layouts. The information in database 32 for each specific vehicle includes the VIN; date purchased, mileage at purchase, and location of purchase; and the detailed repair history for each VIN including the number of attempts made to fix each individual problem, the number of attempts made to fix all problems, the number of calendar days or business days that the vehicle has been out of service during repair attempts, the number of calendar days during which the vehicle has been out of service during repair attempts, the date and content of any official notice given by the consumer to the manufacturer; any other parameters made relevant under consumer protection laws; and which state's laws apply to that vehicle. Additionally, database 32 preferably includes categorization of certain types of repairs including whether a specific defect impairs the value and use of the vehicle, whether it may cause death or serious injury, whether it constitutes a serious safety hazard, whether it constitutes a serious defect in the braking or steering system, and any other categorizations of repairs applicable under applicable consumer protection laws. The database also indicates which VINs are associated with customers that are require “special care.” A special care customer is a customer who has been identified for treatment with special handling. A customer may be identified for special handling either because the customer is a loyal and long term customer or is some other VIP, is considered to be a litigation threat, or for any other reason. The database could include notes regarding the customer's history and recommendations for accommodating the customer, such as giving the customer special care and handling because the customer is perceived as being potentially litigious, or is to be accorded VIP treatment.

A. Alerts and Reports

Manufacturer's computer 34 can issue a number of alerts and reports including: that a vehicle is nearing a Lemon Law limit for that state, that a Lemon Law limit has been exceeded for that vehicle; the number and types of prior repair attempts and the results of those attempts; the number of days previously spent in a shop attempting repairs; whether the customer is a special care customer; any safety recalls issued for that vehicle; and any warranty bulletins for that vehicle. Manufacturer's computer 34 can also issue an alert indicating that a particular unit has already spent an excessive number of days within the current dealer's lot. Such an alert could be helpful, for example, in alerting the dealership and/or the manufacturer that the vehicle has already accrued an excessively long time for a single repair visit, and that the manufacturer should contact the dealer to help resolve any problems in completing the necessary repairs and thus ensure timely completion of the repairs. The alerts may be sent to both the manufacturer and to the dealer via any communication method including email, instant messaging, facsimile, voice message, cellular telephone and pager networks, radio communication links, and/or facsimile.

If the database indicates that a safety recall has been issued that covers that vehicle, and the database or the vehicle's RFID unit does not indicate that the associated repair has been performed yet, an electronic alert message is generated. The message could include, for example, an email to the dealership's service manager indicating the vehicle, its arrival time, and the applicable safety recall(s). The message could also include a notice that would appear on the technician's computer screen indicating the safety recall repair work that needs to be performed. The message on the technician's computer screen could include one or more hypertext links to information about the necessary repair including a parts list, and detailed instructions and illustrations for performing the repair. The alert is preferably sent as soon as possible after the vehicle is detected at the repair facility premises, preferably within at least one day of being detected at the repair facility, and more preferably within at least an hour, and most preferably still within at least one minute.

In one embodiment the manufacturer uses the system to alert dealers that a particular range of VIN numbers is subject to particular safety recalls, and inform the dealer which safety recalls still need to be performed for that particular vehicle. This will help ensure that all applicable recall repairs are performed for every vehicle that enters any dealer's lot.

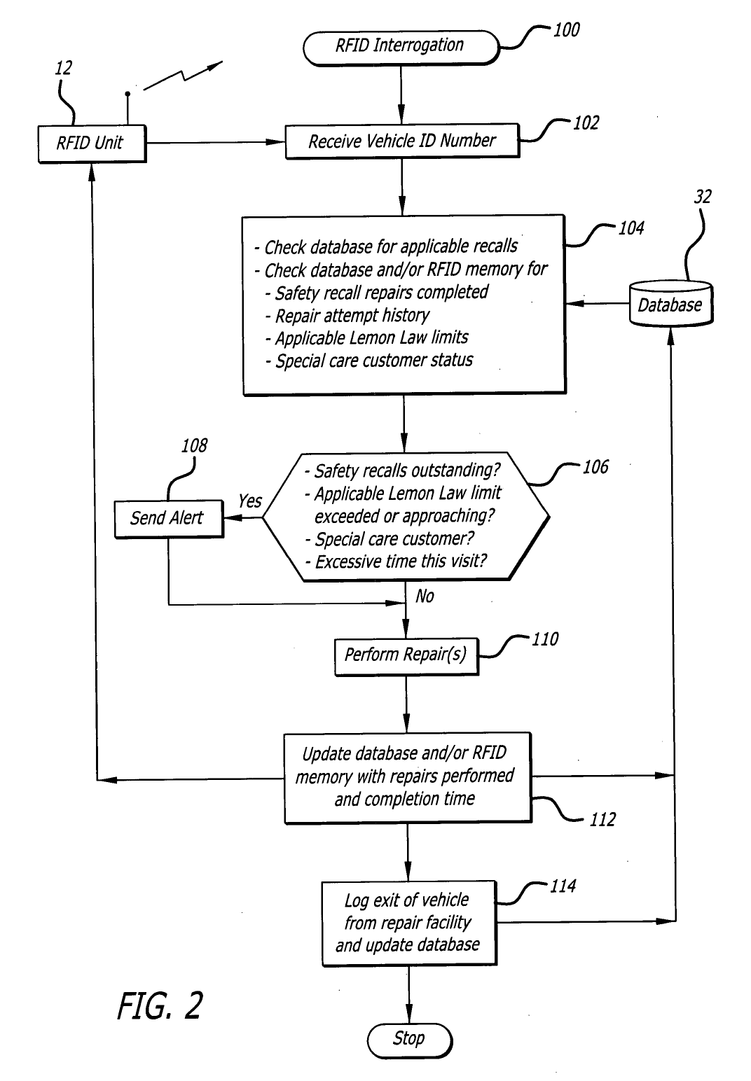

FIG. 2 is a simplified flow diagram for the vehicle alert system. The process begins at step 100 in which the RFID reader sends out an interrogation signal. At step 102 the RFID reader receives back the vehicle's VIN. At step 104 the system checks database 32 for any safety recalls which apply to that vehicle, and checks database 32 and/or the memory within RFID unit 12 for safety recall repairs completed, the repair attempt history, applicable Lemon Law limits, whether the customer is a special care customer, and other pertinent information pertaining to the vehicle and/or the vehicle's owner. At step 106 the system generates any alerts 108 indicating that there are safety recalls still outstanding to be performed, that applicable Lemon Law limits are being approached or have already been exceeded, that the customer is a special care customer, that the vehicle has already spent an excessive amount of time at the repair facility for this visit, or other useful messages. At step 110 any indicated repairs are performed. At step 112 the system updates database 32 and/or the memory within RFID unit 12 with the repairs performed and the completion time for those repairs. At step 114 the system detects that the vehicle has exited from the repair facility, and updates database 32 with the exit time.

The system can also be used to generate a number of reports that are useful for management purposes. The system can generate a report for a repair facility and for the manufacturer including textual and graphical representations of the vehicles currently on a particular repair lot awaiting repairs, the amount of time that each unit has spent on the lot, and the amount of time remaining before Lemon Law limits are reached for each particular vehicle currently tendered for repairs. The system can generate reports allowing the manufacturer to compare the average times spent by vehicles in different repair lots awaiting repairs, and the repair lots and the types of repairs which have historically used up a disproportionate share of lemon law time limits for repairs. The reports can be used by the manufacturer to identify bottlenecks within the repair flows, and to address those bottlenecks with proactive measures such as by ensuring a stock of repair parts on hand at each repair facility, providing better training to repair personnel, or other measures.

B. Reimbursement Requests

In one embodiment, the system can be used to automatically generate reimbursement requests by dealerships to the manufacturer, and upon approval to automatically pay the dealer for the repairs. Typically, a dealership which performs a warranty repair on a vehicle sends a request for reimbursement to the manufacturer, with documentation showing which repair(s) were made to which vehicle. Using the present system, when a vehicle enters the dealership facility the vehicle identification number is read from the vehicle by the RFID reader. The dealership's computer 24 then interrogates the master database 34 to determine if any safety recalls have been issued which would include that vehicle, and interrogates the database 34 to determine which if any safety recall repairs have already been performed for that vehicle. Alternatively, if the RFID 12 unit on the vehicle includes the repair history of the vehicle written into the unit's memory, then the dealer's computer obtains that information as well from the RFID unit. Either way, a determination is made of what outstanding safety recalls have yet to be performed. The system presents on the technician's computer screen a list of the outstanding safety recall repairs that have yet to be performed for that vehicle, and/or a list of other common repairs.

Once the associated recall repair is performed, the technician indicates via input to the dealer's computer 24 that the repair has been performed. The technician selects one of the repair items from the list by any computer input method including well known methods such as cursor keys, a computer mouse, or a touch sensitive screen, or selecting a menu item number. Additionally, the technician inputs to the computer any other warranty repairs that have been made, such as an alternator replacement, routine service if covered by the manufacturer's warranty, or any other service that is covered by the manufacturer's warranty. An electronic reimbursement request message is then generated by combining the vehicle identification information and any other information retrieved from the RFID unit 12 on vehicle 10, or any other information about the vehicle or its history retrieved from database 32, the repair work performed by the technician and any other comments entered by the technician, the dealer's identification information and any other particulars collected by the dealer or maintained on the dealer's computer system. The manufacturer then approves the reimbursement request. The approval may be either manual such as requiring a person to somehow input a decision approving the reimbursement, or the approval may be automatic if it meets certain pre-specified criteria for pre-approved reimbursements. The manufacturer then may make the reimbursement payment, either automatically and electronically such as via wire transfer or direct deposit transfer, or may prepare a physical check to be mailed to the dealer. Typically the reimbursements for all warranty repairs will be paid periodically by the manufacturer to the dealers, such as monthly.

RFID reader 22 also detects that vehicle 10 has left the repair facility. RFID reader 22 may comprise one reader, such as a reader located at the entrance/exit to the facility, or one reader whose read range covers the entire repair yard, or may comprise multiple readers to ensure complete coverage of the repair yard plus direction indication, i.e., whether the vehicle has entered or has left the facility. The RFID readers may periodically check for the presence of vehicles by periodically sending out interrogation signals and checking the return signals.

In an alternative embodiment, the presence of a vehicle is sensed using a global positioning system (GPS) receiver, or other electronic mechanism, on the vehicle in combination with a radio frequency transmitter, such that the vehicle transmits its own coordinates. The transmitted signal containing the coordinates of the vehicle is received by a receiver which could be located anywhere within the receiving range for the transmitter. The position signal could be transmitted using the existing cellular telephone network and/or any combination of other well known communication channels, to a central facility (i.e., the master database). The central facility maintains a database of the GPS coordinates of authorized repair facilities. By comparing the vehicle's position to the locations of repair facilities, the central system determines when a vehicle enters a repair facility and when it leaves, and at which facility. The vehicle could transmit its coordinates periodically, or only in response to an interrogation or “wake up” signal sent by a transmitter located at a repair facility. In still further embodiments, the presence of the vehicle at a repair facility could be sensed using any number of known position determining or object sensing technologies, or technologies developed in the future.

As used herein, the term “vehicle identification number” should be interpreted in its broadest sense to encompass any sequence of characters that identifies a vehicle. The term “manufacturer” should be interpreted in its broadest sense to encompass the manufacturer, any affiliated company, any company with whom the manufacturer contracts to receive or process data or other information on behalf of the manufacturer, or any other representative or agent of the manufacturer or other person acting on behalf of or for the benefit of the manufacturer. The term “authorized repair facility” refers to any repair facility which is authorized by the manufacturer to perform service on vehicles produced by the manufacturer, including repairs covered by the manufacturer's warranty and safety recall repairs.

II. Automation of Lender Auditing

A second major aspect of the invention relates to automating the lender auditing process. Many, if not all, retail sellers of vehicles, trailers, boats and equipment finance their inventories with funds provided by wholesale lenders. These lenders have a security interest in the merchandise and the retailer is legally obligated to (i) keep the collateral on its premises and (ii) pay off the loan immediately upon sale of the secured chattel. To protect and monitor their loan collateral, lenders regularly send auditors to the borrowers' facilities to inspect inventory. This is a cumbersome and expensive process that is difficult for both the lender and the borrower. Moreover, the accuracy of hand counting inventory is often confounded and complicated by various factors outside the lender's control. Therefore, it would be highly desirable to automate the audit process using electronic means. Such electronic means would be more accurate and efficient than the current manual process and it could be far less expensive. The present invention would provide this capability as it could monitor the position of products in dealer inventory, electronically notify lenders as products leave the inventory premises, and allow for Internet interactivity. The present invention provides that capability.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. As examples, in addition to radio frequency identification, any suitable vehicle detection and identification technology may be used. Although the invention has been described with reference to a preferred embodiment in which the repair facility's and manufacturer's computers transfer data to and from and communicate via the Internet with the master database maintained within or operatively connected to a webserver, other suitable network configurations could be used including but not limited to client/server configurations. The database could reside anywhere in communication with the network. The necessary calculations and report generation and request generation could be performed on either the repair facility side or the manufacturer side, or even at a third party site. The foregoing are merely examples of variations that may be employed. Accordingly, it is to be understood that the detailed description and the accompanying drawings as set forth hereinabove are not intended to limit the breadth of the present invention, which should be inferred only from the following claims and their appropriately construed legal equivalents.

1-16. (canceled)

17. A system comprising:
an electronic interrogator to automatically detect a presence of a vehicle at a repair facility, the electronic interrogator reading identification information of the vehicle;
a first memory storing safety recall information associated with the identification information;
a computer communicatively coupled to the electronic interrogator and the first memory, the computer receiving the identification information, reading the first memory to obtain the safety recall information associated with the identification information and determine whether a safety recall has been issued for said vehicle, and the computer sending an electronic message to said repair facility indicating that said safety recall has been issued for said vehicle.

18. The system of claim 17 wherein the electronic interrogator reading the identification information includes automatically reading a vehicle identifying number from a transmitter associated with said vehicle.

19. The system of claim 17 wherein said electronic message contains a hypertext link to information pertaining to said safety recall.

20. The system of claim 19 wherein said information includes a parts list and instructions for implementing a recall repair.

21. The system of claim 17,
further comprising a second memory storing information on repairs associated with said safety recall, and
wherein the computer reading the second memory to determine whether a repair associated with said safety recall has been performed for said vehicle, and generating said electronic message only if said safety recall has been issued but said repair has not yet been performed, and wherein said electronic message indicates that said repair has yet to be performed for said vehicle.

22. The system of claim 21 wherein said first and second memories are within a single memory device.

23. The system of claim 21 wherein:
the electronic interrogator is located at an authorized repair facility and said automatically detecting step is performed at the authorized repair facility;
said first memory is located within a database maintained by a manufacturer of said vehicle; and
said second memory comprises a radio frequency identification read/write memory associated with said vehicle.

24. The system of claim 21 wherein:
the electronic interrogator is located at an authorized repair facility and said automatically detecting step is performed at the authorized repair facility;
said first and second memories are located within a database maintained by a manufacturer of said vehicle; and
said electronic message is sent to said repair facility.

25. The system of claim 17 wherein said electronic message comprises at least one of an email, an instant message, a facsimile, a pager message, and a telephone message.

26-30. (canceled)
